(19) United States
(12) Patent Application Publication
(10) Pub. No.: US 2006/0101648 A1
(43) Pub. Date: May 18, 2006

(54) Disposable spoon

(76) Inventor: Joachim Muhling, Hopfingen (DE)

Correspondence Address: KRIEGSMAN & KRIEGSMAN, 665 Franklin Street, Framingham, MA, 01702, US

(21) Appl. No.: 11/281,867

(22) Filed: Nov. 17, 2005

(30) Foreign Application Priority Data
Nov. 18, 2004 (DE) 102004055796.9

(51) Int. Cl. A47J 43/28

(52) U.S. Cl. 30/324

(57) ABSTRACT

The invention relates to a disposable spoon with a bowl part (12) and, arranged thereon, a handle part (14) which comprises at least one hollow compartment (16, 18, 28) for accommodating and dispensing products, in particular foods or food ingredients, wherein the handle part (14) arranged on the bowl part (12) has a first hollow compartment (16) which is formed by an inherently rigid wall section, wherein the first hollow compartment (16) is assigned at least one further hollow compartment (18, 28), and wherein a predetermined breaking point for detaching the mutually assigned hollow compartments (16, 18, 28) is provided between the first hollow compartment (16) and at least one further hollow compartment (18, 28).

### BACKGROUND OF THE INVENTION

The invention relates to a disposable spoon with a bowl part and, arranged thereon, a handle part which has at least a first hollow compartment for accommodating and dispensing products, in particular foods or food ingredients.

### TECHNICAL FIELD

DE 38 41 075 A1 has disclosed a disposable spoon with a bowl part and a handle part arranged thereon, in which two chambers which are arranged in the handle part and serve to accommodate foodstuffs or other goods are provided. The stick-shaped container comprising the handle part is formed from plastic, with the chambers being arranged one beside the other in parallel. The chambers are closed at one end by means of a pull-off cover film.

This disposable spoon has the disadvantage that the manufacture of such a spoon is labour- and cost-intensive. In addition, the arrangement of chambers arranged one beside the other results in a disposable spoon with a very wide handle part.

Furthermore, DE 91 08 429 has disclosed a disposable spoon which comprises a handle of tubular design. A bowl-shaped end is provided at one end of this handle. A soluble and edible seal is introduced into the tubular handle close to the bowl-shaped end, the seal dissolving upon use of the disposable spoon after it has been dipped into the drink, with the result that the ingredients provided in the tubular part are stirred in the drink. This design has the disadvantage that the ingredient can only be measured out with difficulty, if at all.

Furthermore, this publication features an alternative embodiment in which the handle part has only one chamber, the end opposite to the bowl part being opened by means of a tear tab or a closure plug so that the ingredient can be discharged in the desired quantity. This alternative embodiment has the disadvantage that only one product or food ingredient is stored and made available in the disposable spoon.

### SUMMARY OF THE INVENTION

The object on which the invention is based is to provide a disposable spoon which comprises a plurality of hollow compartments for accommodating various products and, while retaining the stirring function, allows the respective product to be added according to choice.

This object is achieved according to the invention by means of a disposable spoon according to the features of claim 1. Further advantageous developments are given in the further dependent claims.

The disposable spoon according to the invention has at least two hollow compartments for accommodating products, a predetermined breaking point being provided between the first and at least one further hollow compartment. Furthermore, the first hollow compartment is formed by an inherently rigid wall section. This makes it possible for the stirring function of the disposable spoon to be maintained after the at least one further hollow compartment has been detached and parted from the first hollow compartment. In addition, the product can be discharged according to choice from the first and/or the second or further hollow compartment. This construction permits simple and reliable handling.

According to an advantageous refinement of the invention, provision is made for the at least one further hollow compartment to be held by means of a casing with respect to the first hollow compartment and for the casing to have a predetermined breaking point at or close to the parting point between two mutually assigned hollow compartments. This makes it possible to provide simple handling and use, thereby enabling the respective hollow compartments to be parted from the casing without unintentionally damaging or opening the hollow compartments. The casing allows one or more hollow compartments to be assigned to one another and packaged jointly with respect to the handle part and bowl part. Preferably, a plurality of hollow compartments are arranged one behind the other. This casing is advantageously designed as an advertising or information carrier. Apart from performing a protective function, in particular forming a sterile packaging, the casing may also perform a holding function or a reinforcing function for one or more hollow compartments in order to protect the products in the hollow compartments during transportation and storage until such time as they are dispensed.

The predetermined breaking point provided on the casing is preferably formed by a perforated parting line. The casing can thus be broken open and the hollow compartments parted from one another by means of a simple bending movement.

According to an alternative refinement of the casing, provision is made for the predetermined breaking point to be formed by a detachable band or a tear tab. The band may completely enclose the casing, with the result that two parted sections of the casing are present after the band has been removed, and release the mutually assigned hollow compartments in particular by being pulled off or pulled apart.

According to a further alternative refinement of the casing, provision is made for the predetermined breaking point to be connected by means of two fastening sections which are assigned to one another or arranged one above the other and which have a detachable bonded connection. The fastening sections may be detached by a single or multiple bending movement or a pulling-off action, it thereby being possible for the at least two hollow compartments arranged relative to one another to be separated from one another.

According to an alternative and advantageous refinement of the invention, provision is made for a first hollow compartment to have at one end a closure section which, in conjunction with a further hollow compartment, forms a closure for the further hollow compartment. A closure situated at the parting point of two hollow compartments arranged relative to one another is provided by the at least partial interengagement of the closure section of a first hollow compartment into a further hollow compartment.

Provision is advantageously made for the closure section of one of the hollow compartments to be connected to the further hollow compartment by means of a detachable bonded connection or a predetermined breaking point. Simple and reliable handling of the disposable spoon is provided. At the same time it can thus be ensured that a controlled opening of one hollow compartment is permitted when the two hollow compartments are being parted. For example, the first hollow compartment, which forms the handle part of the disposable spoon, is closed by a second hollow compartment with a closure plug. Sugar may be provided for example in the first hollow compartment and metered out in the desired amount after the second hollow compartment has been detached.

According to a further advantageous refinement of the invention, provision is made for the first hollow compartment to be designed in the shape of a cartridge. This makes it possible to have a tubular handle part in which a plurality of cartridges, which are preferably formed as fixed chambers, may be arranged one behind the other and processed in one wrapping operation by means of a common casing.

According to a preferred embodiment of the invention, provision is made for the hollow compartment to be formed with a closure in the form of a tear-off tab or a pull-off closure plug. This enables a plurality of separately produced hollow compartments with different products for a disposable spoon to be put together and packaged jointly to form a handle part.

Furthermore, provision is preferably made for a first hollow compartment to be formed by a packaging which is not inherently rigid and to comprise a tear notch or tear tab. Such a hollow compartment may be provided for example at a free end of the handle part situated opposite the bowl part.

Hollow compartments having a packaging which is not inherently rigid may preferably be filled with pourable or liquid products, so that the packaging is reinforced by the filled contents. This facilitates handling during the manufacture of disposable spoons.

According to a further preferred refinement of the invention, provision is made for the first hollow compartment to comprise on the handle part a length which corresponds at least to the height of a vessel, in particular to a coffee cup or tea cup, and is preferably at least 5 cm long. As a result, the functional capacity of the spoon is maintained after the at least one further hollow compartment has been separated from the first hollow compartment.

According to a preferred development of the invention, the bowl and handle part is produced from paper, a paper-like material, natural fibre substances, from paperboard, plastic, wood or metal. Various materials may be used depending on the intended use and the place of use. All the materials are recyclable. Preference is given to using paper or paper-like materials. For the purpose of packaging liquids, the materials consisting of paperboard, paper or natural fibre substances are provided with a liquid-repelling coating or a varnish layer. For high-grade applications, use may also be made of metallic materials.

The casing, which is provided on the handle part, is preferably formed from a paper, plastic or metal sheet. These casings are preferably printed on prior to processing. Various aesthetic designs may be permitted by selecting different casings while keeping the same construction for the handle part having further hollow compartments.

### BRIEF DESCRIPTION OF THE FIGURES

The invention and also further advantageous embodiments and developments thereof are described and explained in more detail below with the aid of the examples represented in the drawings. The features to be taken from the description and the drawings may, according to the invention, be applied individually in their own right or multiply in any desired combination. In the drawings:

FIG. 1 shows a schematic representation of a disposable spoon in an embodiment according to the invention,

FIG. 2 shows a schematic representation of a further embodiment of a disposable spoon, and

FIGS. 3 to 5 shows schematic representations of the disposable spoon according to FIG. 2 in use.

### DETAILED DESCRIPTION OF THE INVENTION

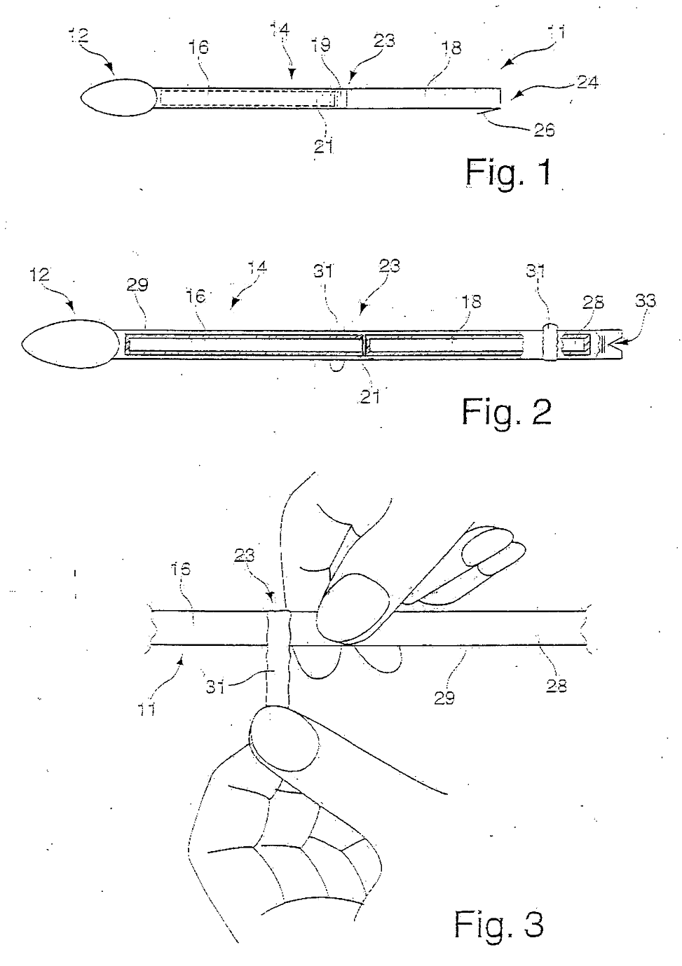

FIG. 1 schematically represents a disposable spoon 11 according to the invention. This disposable spoon 11 has a bowl part 12 for stirring liquids. This is adjoined by a handle part 14 which is preferably of tubular design. The handle part 14 comprises a first hollow compartment 16 which is arranged fixedly with respect to the bowl part 12. The handle part 14 forming the first hollow compartment 16 is formed from a wall section which is inherently rigid or by an insert part composed of an independent wall section. This may be a reinforced paper, paperboard, plastic, natural fibre material, metallic material or wood, for example. A further hollow compartment 18 is arranged at an end of the handle part 14 situated opposite the bowl part 12, the outer wall of which further hollow compartment is preferably formed flush with the respect to the outer wall of the first hollow compartment 16 so as to form a handle part. The further hollow compartment 18 comprises a closure plug 19 which engages in an opening 21 in the first hollow compartment 16 and closes the first hollow compartment 16. The closure plug 19 may be held in the opening 21 by means of a bonded connection. Furthermore, it may be provided for the closure plug 19 to be compressed or accommodated with prestress with respect to the opening 21 in a manner similar to a bottle closure in the form of a cork. The closure of the first hollow compartment 16 is only by way of example and is situated at a parting point 23 between the first hollow compartment 16 and at least one further hollow compartment 18. The further hollow compartment 18 has at its free end a film closure 24 which can be simply opened by means of a tear-off tab 26. Alternatively, the film closure 24 may also be impressed. Furthermore, a bending point with a notch may be provided as the closure in order to facilitate tearing.

The principle of a parting point 23 represented in FIG. 1 may be provided in a multiply repeated manner. The length of the individual hollow compartments 18 may here be tailored to the type of products to be accommodated and the compartments may have different lengths. For example, a relatively short hollow compartment may be provided for accommodating a sweetener or a lemon concentrate. A relatively long hollow compartment may be provided for accommodating milk in liquid form or powder form. If the handle part is in not intended to be of tubular design over the entire length, the individual hollow compartments 18 may also be designed differently in their scope. As a result, curved profiles may also be provided along a handle part which are tailored or approximated to symbols, towers or other object geometries. Such a disposable spoon is not restricted to the use of drinks, in particular hot drinks such as coffee, tea or cocoa, for example, but may also be provided for example for soups or other convenience food.

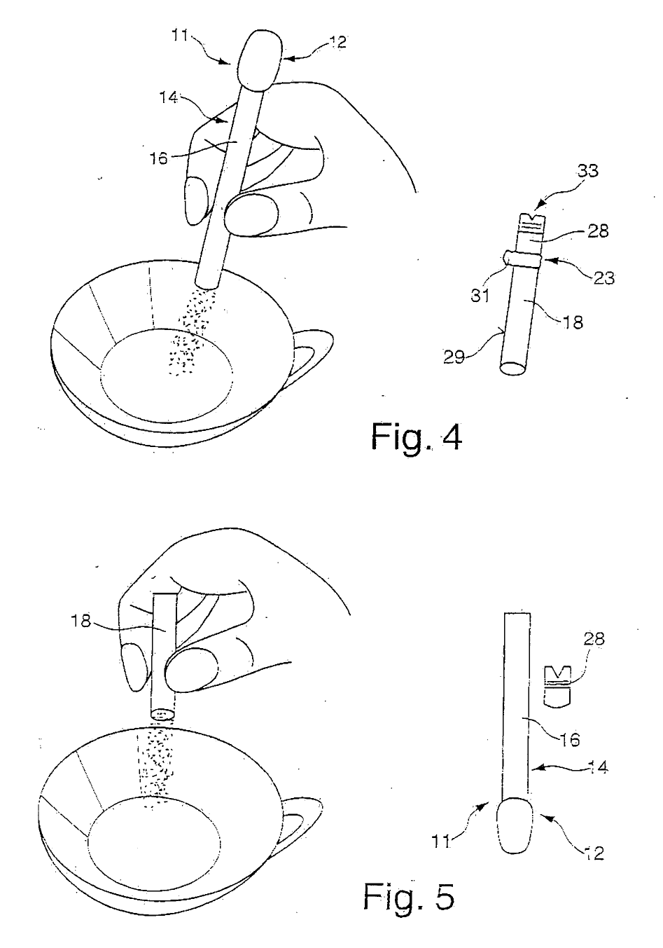

FIG. 2 represents an alternative embodiment of a disposable spoon 11 according to the invention. In this exemplary embodiment, the hollow compartment 18 is assigned a further hollow compartment 28. The hollow compartments 16, 18, 28 are held to form a common handle part 14 and provided as a disposable spoon 11 by means of a common casing 29. The casing 29 has a tear-open tab or band 31 which extends over the entire periphery of the hollow compartment 18, 28. By simply pulling off the band 31, as is represented for example in FIG. 3, the parting point 23 is released so that the disposable spoon 11 with the bowl part 12 and a section of the handle part 14 which encloses the first hollow compartment 16 is parted from the further section of the handle part 14 which encloses the further hollow compartment 18 and 28. The first hollow compartment 16 is thus accessible. If sugar, for example, is situated in this hollow compartment, it can be metered out as shown by the representation in FIG. 4. If it is not desired to dispense sugar, or after the product has been dispensed from the first hollow compartment 16, the disposable spoon 11 with the handle part 14 can be used for stirring. The hollow compartment 18 may also be closed by a closure and opened as required. The casing 29 enables the hollow compartments 18 and 28 to be provided separately and in closed form for further use. If it is intended for a product from the further hollow compartment 28 to be added, a notch 33 is torn to allow the hollow compartment 28 to be opened. Further alternative closures which permit ready accessibility to the product in the hollow compartment 28 are also conceivable, such as, for example, a tear-open tab or a detachable bonding point or a perforated parting point.

FIG. 5 represents a product being discharged from the further hollow compartment 18. Provision is made in the exemplary embodiment for the closure of the hollow compartment 18 to be provided by the hollow compartment 28 similarly to the closure of the first hollow compartment 16. The hollow compartments 28 and 18 are parted from one another by pulling off the band 31 at the parting point 23, so that it is now possible to subsequently dispense products. Alternatively, provision may be made for a detachable cover film, tear tab, perforations, bending point or the like to be provided at an end of the hollow compartment 16, 18 directed towards the parting point 23, in order to permit accessibility to the hollow compartment 16, 18.

The casing 29 may extend over the entire length of the handle part 14. Alternatively, provision may be made to provide only a covering of the parting point 23 between two mutually adjacent hollow compartments 16, 18, 28.

The two hollow compartments 18 and 28 may either have inherently rigid wall sections or consist of dimensionally unstable material.

The casing 29 may alternatively be formed by a spiral wrapping which is perforated in the region of the parting points 23. Furthermore, the casing 29 may be designed as a plug-on sleeve which, for the purpose of dispensing the products, is pulled off the first hollow compartment 16 in order then to dispense or make accessible the individual hollow compartments 18, 28. In the design as a sleeve, one or more hollow compartments 18, 28, which are preferably designed in the shape of a cartridge, are introduced one after the other into the sleeve in order subsequently to be plugged onto the first hollow compartment 16 of the handle part 14. Alternatively, the handle part 14 may also be designed as a sleeve which is filled successively with individual hollow compartments 16, 18, 28 as a packaging unit before the sleeve is closed with a closure in the form of a closure plug, closure cap, closure film or the like.

In a further alternative embodiment which has not been represented in more detail, provision may be made for a sleeve to be made available as the handle part, which sleeve comprises parting points at predetermined distances from one another. Following the filling of a respective product, a closure plug which is positioned with respect to the parting point is introduced into the sleeve. The individual sleeve sections may be permitted to separate by bending the sleeve in the region of the parting point, with at least one of the two adjacent hollow compartments remaining closed due to the arrangement of the closure plug in the parting section.

1. Disposable spoon with a bowl part (12) and, arranged thereon, a handle part (14) which comprises at least one hollow compartment (16, 18, 28) for accommodating and dispensing products, in particular foods or food ingredients, characterized in that the handle part (14) arranged on the bowl part (12) has a first hollow compartment (16) which is formed by an inherently rigid wall section, in that the first hollow compartment (16) is assigned at least one further hollow compartment (18, 28), and in that a predetermined breaking point for detaching the mutually assigned hollow compartments (16, 18, 28) is provided between the first hollow compartment (16) and at least one further hollow compartment (18, 28).

2. Disposable spoon according to claim 1, characterized in that the at least one further hollow compartment (18, 28) is held by means of a casing (29) with respect to the first hollow compartment (16), and in that the casing (29) has a predetermined breaking point at or close to a parting point (23) between two mutually assigned hollow compartments (16, 18, 28).

3. Disposable spoon according to claim 1, characterized in that the predetermined breaking point between two mutually assigned hollow compartments (16, 18, 28) is formed by perforations.

4. Disposable spoon according to claim 1, characterized in that the predetermined breaking point is formed by a detachable band (31) or tear tab.

5. Disposable spoon according to claim 1, characterized in that the predetermined breaking point is formed by a detachable bonded connection of two fastening sections which are arranged relative to one another or one above the other.

6. Disposable spoon according to claim 1, characterized in that a hollow compartment (18 or 21) has at one end a closure section (19), in particular a closure plug, which, in conjunction with a further hollow compartment (16, 18), forms a closure for the further hollow compartment (16, 18).

7. Disposable spoon according to claim 6, characterized in that the closure section (19) of one of the hollow compartments (18, 28) is arranged detachably on the further hollow compartment (16, 18, 28) by means of a detachable bonded connection or predetermined breaking point.

8. Disposable spoon according to claim 1, characterized in that the hollow compartment (16, 18, 28) is designed in the shape of a cartridge.

9. Disposable spoon according to claim 1, characterized in that the hollow compartment (16, 18, 28) has a closure with a tear-off tab (26) or a pull-off closure plug or closure cap.

10. Disposable spoon according to claim 1, characterized in that the hollow compartment (18, 28) is formed from a packaging which is not inherently rigid and has a tear notch (33), tear tab, bending point or perforations for opening.

11. Disposable spoon according to claim 10, characterized in that the hollow compartment (18, 28) formed from a packaging which is not inherently rigid is reinforced by the filling of the product.

12. Disposable spoon according to claim 1, characterized in that the first hollow compartment (16) on the handle part (14) has a length which corresponds at least to the height of a cup or a vessel and is preferably at least 5 cm long.

13. Disposable spoon according to claim 1, characterized in that the bowl part (12) and handle part (14) are produced from a recyclable material.

14. Disposable spoon according to claim 13, characterized in that the bowl part (12) and handle part (14) are produced from paper, paper-like or natural fibre-like material, natural substances, plastic, wood or metal.

15. Disposable spoon according to claim 2, characterized in that the casing is formed from a sheet of paper, plastic, metal or natural fibres.
